(19) United States
(12) Patent Application Publication
(10) Pub. No.: US 2026/0202435 A1
(43) Pub. Date: Jul. 16, 2026

(54) PREPROCESSING METHOD AND PREPROCESSING APPARATUS

(71) Applicant: SHIMADZU CORPORATION, Kyoto (JP)

(72) Inventor: Yudai FUJIWARA, Kyoto-shi (JP)

(73) Assignee: SHIMADZU CORPORATION, Kyoto (JP)

(21) Appl. No.: 19/393,371

(22) Filed: Nov. 18, 2025

(30) Foreign Application Priority Data
Jan. 14, 2025 (JP) 2025-005026

(51) Int. Cl. G01N 35/10; G01N 35/00

(52) U.S. Cl. CPC G01N 35/1002; G01N 35/0099; G01N 35/1065; G01N 2035/106

(57) ABSTRACT

A preprocessing method according to the present invention is a preprocessing method for performing unit preprocessing two or more times on the same sample, the unit preprocessing sequentially performing a solvent addition step of adding a solvent to a sample container housing a sample to prepare a mixture of the sample and the solvent, a centrifugation step of centrifuging the mixture, and a suction step of inserting a suction tube into the sample container such that a height of a tip thereof from a bottom of the sample container becomes a predetermined height and suctioning a supernatant of the mixture with the suction tube, the preprocessing method having, as the unit preprocessing, a first unit preprocessing and a second unit preprocessing performed after the first unit preprocessing, wherein the predetermined height in the suction step of the first unit preprocessing is a first height, and the predetermined height in the suction step of the second unit preprocessing is a second height that is higher than the first height.

### TECHNICAL FIELD

The present invention relates to a preprocessing method for a sample and a preprocessing apparatus for preprocessing a sample.

### BACKGROUND ART

When analyzing a sample by chromatography, mass spectrometry, or the like, preprocessing of the sample may be performed. For example, when analyzing a substance (substance to be analyzed) contained in a sample of biological origin (biological sample), a series of operations is performed one or more times, the series of operations including adding a solvent to a sample container housing the biological sample, agitating this, performing centrifugation, and suctioning the supernatant with a dispenser such as a pipette. This makes it possible to prepare a final sample with a high proportion (purity) of the substance to be analyzed from the supernatant or precipitate of the centrifuged biological sample.

Preprocessing may be performed manually, but it is often performed automatically by a preprocessing apparatus in order to prepare the final sample safely, quickly, and uniformly.

### CITATION LIST

### Patent Literature

[PTL 1] JP 2022-094535 A.

[PTL 2] JP 2024-039363 A.

### SUMMARY OF INVENTION

### Technical Problem

In the preprocessing described above, if the height position from the bottom of the sample container of the tip of the dispenser that suctions the supernatant is too low, the dispenser will also suction the precipitate. Conversely, if the position of the tip is too high, the suctioned amount of the supernatant will be small. Therefore, in the preprocessing described above, in order to suction as much supernatant as possible at one time while avoiding suctioning the precipitate in the sample container, it is necessary to detect the height from the bottom of the sample container of the boundary between the precipitate and the supernatant in the sample container with a high-precision sensor, and then to precisely control the dispenser to position the tip of the dispenser at a predetermined height slightly above the boundary. As described above, conventionally, a great deal of effort has been expended to position the tip at an ideal height.

A problem to be solved by the present invention is to reduce such effort for preprocessing.

### Solution to Problem

A preprocessing method according to the present invention, which has been made to solve the above problem, is a preprocessing method for performing unit preprocessing two or more times on the same sample, the unit preprocessing sequentially performing: a solvent addition step of adding a solvent to a sample container housing a sample to prepare a mixture of the sample and the solvent; a centrifugation step of centrifuging the mixture; and a suction step of inserting a suction tube into the sample container such that a height of a tip thereof from a bottom of the sample container becomes a predetermined height, and suctioning a supernatant of the mixture with the suction tube, the preprocessing method having, as the unit preprocessing, a first unit preprocessing and a second unit preprocessing performed after the first unit preprocessing, wherein the predetermined height in the suction step of the first unit preprocessing is a first height, and the predetermined height in the suction step of the second unit preprocessing is a second height that is higher than the first height.

In the present invention, the preprocessing method for performing the second unit preprocessing after the first unit preprocessing includes a configuration in which unit preprocessing under the same or different conditions is repeated two or three or more times. When unit preprocessing is repeated three or more times, the “first unit preprocessing” is typically the first unit preprocessing, but may be the second or a subsequent unit preprocessing. In addition, there may be cases where two or more unit preprocessing steps correspond to the “first unit preprocessing”. Examples thereof include a case where the height of the tip of the suction tube from the bottom of the sample container in the first and third unit preprocessing steps is made lower than that in the second and fourth unit preprocessing steps, respectively, or a case where the height of the tip of the suction tube from the bottom of the sample container is gradually increased in three or more unit preprocessing steps.

A preprocessing apparatus according to the present invention, which has been made to solve the above problem, comprises: a container holding unit that holds a sample container; a suction tube mounting unit to which a suction tube is detachably mounted; a suction and discharge unit that suctions and discharges a liquid with respect to the sample container held by the container holding unit through the suction tube mounted to the suction tube mounting unit; a centrifugation unit; a container moving unit that grips the sample container and moves the sample container between the container holding unit and the centrifugation unit; and a control unit that controls the suction and discharge unit and the container moving unit, wherein the control unit sequentially performs, on the same sample, a first unit preprocessing and a second unit preprocessing, which are unit preprocessing for sequentially performing: a solvent addition step of adding a solvent to the sample container held by the container holding unit to prepare a mixture of a sample and the solvent; a first moving step of moving the sample container from the container holding unit to the centrifugation unit; a second moving step of moving the sample container, after the mixture has been centrifuged in the centrifugation unit, to the container holding unit; and a suction step of inserting the suction tube into the sample container held by the container holding unit such that a height of a tip thereof from a bottom of the sample container becomes a predetermined height, and suctioning a supernatant of the mixture with the suction tube, wherein the first unit preprocessing sets the predetermined height in the suction step to a first height, and the second unit preprocessing sets the predetermined height in the suction step to a second height that is higher than the first height.

In the preprocessing apparatus according to the present invention, the container holding unit and the centrifugation unit may be integral or may be provided separately.

### Advantageous Effects of Invention

The present inventor has found that in preprocessing in which a series of operations of adding a solvent to a sample container housing a sample, centrifuging this, and suctioning the supernatant with a suction tube is performed one or more times, in a stage where the number of times centrifugation is performed is small, a substance to be analyzed and impurities are not completely separated and precipitate in a state of being aggregated with each other, so that even if the distance between the tip of the tip and the precipitate is short, it is rare for the precipitate to be suctioned by the tip, and that as the number of times centrifugation is performed increases, the degree of aggregation of the substance to be analyzed and the impurities decreases, and the precipitate becomes more likely to be suctioned by the tip, and has completed the present invention.

According to the present invention, the height of the tip of the suction tube from the bottom of the sample container in the suction step of the first unit preprocessing is lower than that in the suction step of the second unit preprocessing performed after the first unit preprocessing. Therefore, in the suction step of the first unit preprocessing, even if there is an error in the control of the suction tube and the position of its tip becomes higher than expected, an amount of supernatant comparable to that in the suction step of the second unit preprocessing can be suctioned, so the influence of the error can be reduced. Conversely, even if the position of the tip of the suction tube becomes lower than expected, the possibility that the suction tube will suction the precipitate is lower than in the suction step of the second unit preprocessing. Then, since the supernatant is efficiently suctioned in the suction step of the first unit preprocessing in this way, the concentration of the substance contained in the supernatant suctioned in the suction step of the second unit preprocessing is lower than that in the suction step of the first unit preprocessing. Therefore, in the suction step of the second unit preprocessing, even if the position of the tip of the suction tube becomes higher than expected, the amount of the substance contained in the supernatant that could not be suctioned is small, so the influence of the error is smaller than in the suction step of the first unit preprocessing. In addition, in the suction step of the second unit preprocessing, the degree of aggregation of the precipitate is low and the precipitate is more likely to be suctioned, so by making the position of the tip of the suction tube in the suction step of the second unit preprocessing higher than that in the suction step of the first unit preprocessing, the possibility of suctioning the precipitate can be reduced even if the position of the tip of the suction tube becomes lower than expected.

Therefore, according to the present invention, since the allowable range of the control error of the dispenser is wide, the effort required for preprocessing is reduced.

### BRIEF DESCRIPTION OF DRAWINGS

FIG. 1 is a schematic configuration diagram of a preprocessing apparatus according to an embodiment.

FIG. 2 is a flowchart showing the procedure of a preprocessing method according to the embodiment.

FIG. 3 is a diagram schematically showing a tip attachment operation according to the embodiment.

FIG. 4 is a diagram schematically showing a state where a solvent is added to a sample container and agitated in the embodiment.

FIG. 5 is a diagram schematically showing a state where the supernatant obtained by centrifuging a mixture of a sample and a solvent is suctioned in the embodiment.

### DESCRIPTION OF EMBODIMENTS

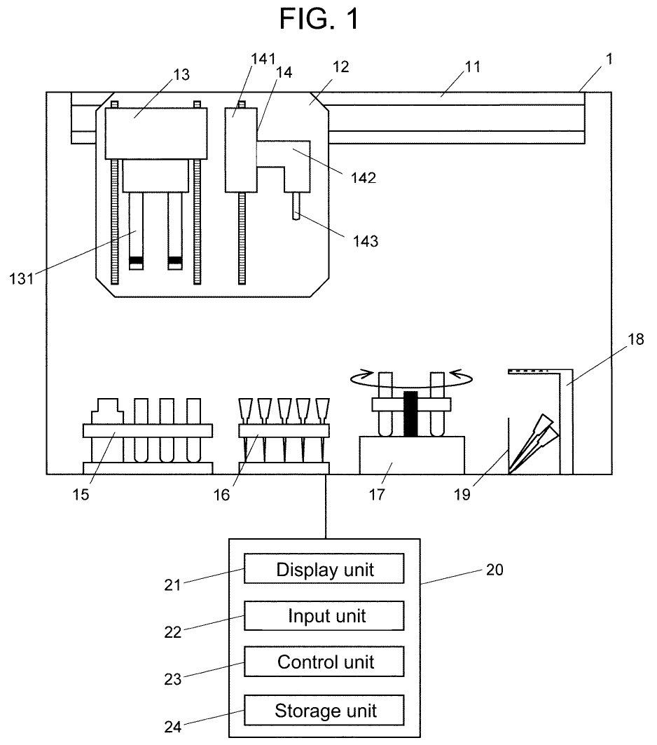

An exemplary embodiment of a preprocessing method and a preprocessing apparatus according to the present invention will be described with reference to the drawings. FIG. 1 is a schematic configuration diagram of a preprocessing apparatus according to the embodiment. The preprocessing apparatus 1 includes a rail 11, a moving plate 12, a container take-out unit 13, a dispensing unit 14, a container holding unit 15, a tip holding unit 16, a centrifugation unit 17, a tip detachment unit 18, a used tip case 19, and a computer 20. The rail 11 is for the moving plate 12 to move substantially horizontally within the preprocessing apparatus 1, and can have any known configuration. The moving plate 12 horizontally moves in the preprocessing apparatus 1 along the rail 11 while holding the container take-out unit 13 and the dispensing unit 14 so as to be movable up and down. The container take-out unit 13 includes a hand 131 for gripping a sample container housing a sample to be preprocessed and a solvent container housing a solvent (including a reagent). The hand 131 preferably has a non-slip member made of rubber or the like at its tip. The dispensing unit 14 is made of a lightweight material (such as aluminum) and includes a height adjustment unit 141 attached to the moving plate 12 so as to be movable up and down, an arm 142 extending from a side surface of the height adjustment unit 141, and a tapered and hollow tip mounting unit 143 provided downward at the tip of the arm 142. That is, the dispensing unit 14 according to the embodiment has a configuration in which the height adjustment unit 141 and the tip mounting unit 143 are not coaxial, in other words, the height adjustment unit 141 is located on a side that is not directly above the tip mounting unit 143. In the drawing, the arm 142 extends to the right in the plane of the paper, but the direction of the arm 142 is not limited to this, and it may extend toward the front side of the plane of the paper. Note that it is not essential for the dispensing unit 14 to perform dispensing using a tip, and it may be provided with a needle instead of the tip mounting unit 143. In this case, the configuration related to tips in the preprocessing apparatus 1 is not necessary, but it is preferable to provide a needle washing unit (not shown) that houses a solvent for washing the needle instead. The container take-out unit 13 and the dispensing unit 14 can move freely within the preprocessing apparatus 1 in the range where the rail 11 is laid, by their own up-and-down movement along the moving plate 12 and the horizontal movement of the moving plate 12. The container holding unit 15 is, for example, a disk-shaped rack having a plurality of openings, and is preferably controlled to rotate around the center of the disk to position a desired sample container and solvent container at a predetermined take-out position. The tip holding unit 16 is also preferably of the same configuration as the container holding unit 15. The centrifugation unit 17 receives the sample container taken out from the container holding unit 15 by the container take-out unit 13 and performs centrifugation. The centrifugation unit 17 preferably has an agitation function in addition to the centrifugation function, but this is not essential. The tip detachment unit 18 is, for example, one having a slit into which the tip mounting unit 143 can enter and which is narrower than the tip. In the tip detachment unit 18 of such a form, the tip mounting unit 143 enters the slit, and by rising from that state, the tip is caught by the slit and detaches from the tip mounting unit 143. The detached tip is stored in the used tip case 19. The computer 20 includes a display unit 21, an input unit 22, a control unit 23, and a storage unit 24. The computer 20 may be built into the preprocessing apparatus 1, or may be installed externally as a personal computer or the like.

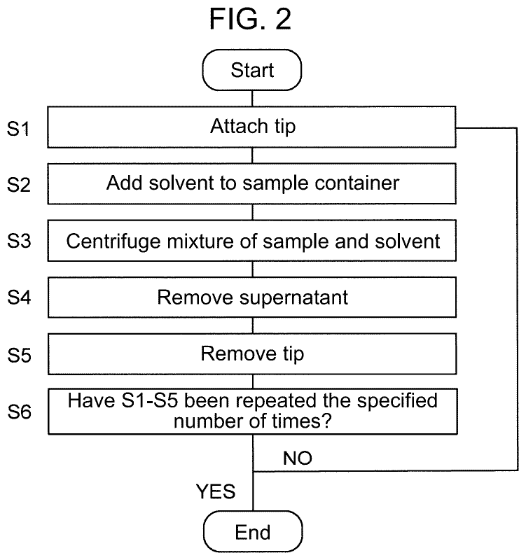

FIG. 2 is a flowchart showing the procedure of the preprocessing method according to the embodiment. The preprocessing method according to the embodiment performs a series of operations (this will be referred to as unit preprocessing) a predetermined number of times (usually, multiple times), the series of operations including attaching a tip to the dispensing unit 14 (step S1), adding a solvent to a sample container to prepare a mixture of the sample and the solvent (step S2), centrifuging this (step S3), suctioning and removing the supernatant (step S4), and detaching the tip of the dispensing unit 14 (step S5). Note that the operation of agitating the mixture of the sample and the solvent may be performed together in either step S2 or step S3. That is, after adding the solvent to the sample container and agitating this, centrifugation may be performed.

A user sets a sample container housing a sample to be preprocessed and a solvent container housing a solvent in the container holding unit 15, and sets tips to be used for preprocessing in the tip holding unit 16, and then instructs the execution of preprocessing through the input unit 22 in accordance with guidance displayed on the display unit 21. However, setting the solvent container is not essential, and a solvent tank (not shown) provided inside or outside the preprocessing apparatus 1 and the dispensing unit 14 may be connected by a tube so that the solvent is discharged from the dispensing unit 14 as needed. The control unit 23 receives an instruction from the user and repeatedly performs preprocessing under predetermined preprocessing conditions, specifically, unit preprocessing consisting of steps S1 to S5 a predetermined number of times. Examples of the predetermined preprocessing conditions include the amount of solvent to be added to the sample container (this is referred to as a reference amount), the number of agitations, the number of revolutions per minute for centrifugation, the height of the tip of the tip from the bottom of the sample container when suctioning the supernatant, the number of times to repeat the unit preprocessing, and the like. These preprocessing conditions may be input by the user when instructing the execution of preprocessing, or may be automatically or manually selected by the user from a database for each type and amount of sample, which is stored in advance in the storage unit 24. The preprocessing conditions for each unit preprocessing may be the same or different.

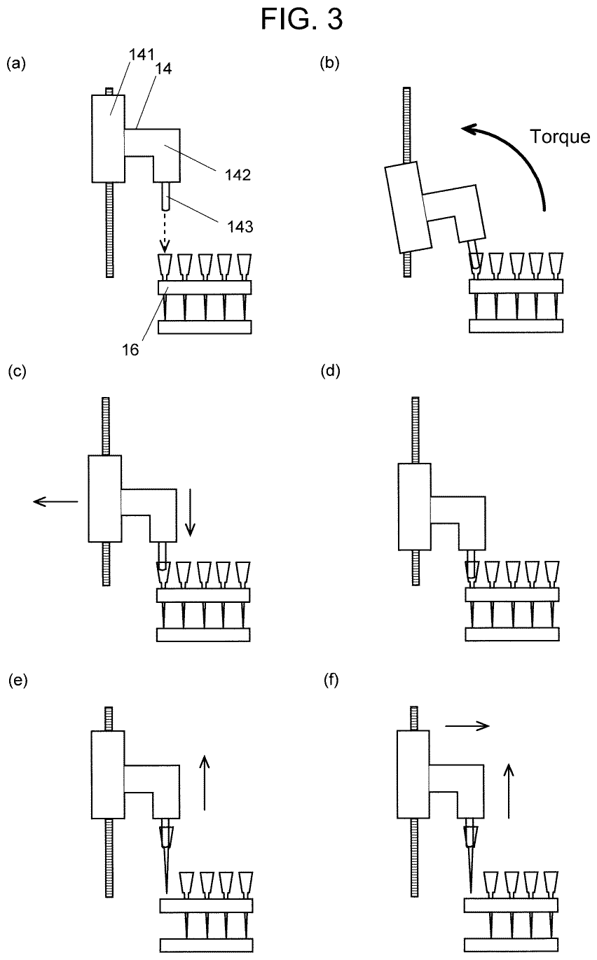

FIG. 3 is a diagram schematically showing a tip attachment operation according to the embodiment. In step S1, the control unit 23 controls the dispensing unit 14 and the tip holding unit 16 to position the tip mounting unit 143 directly above a desired tip, and lowers the dispensing unit 14 to insert the tip mounting unit 143 into the tip (FIG. 3(a)). By the way, in a conventional preprocessing apparatus, a torque may be generated by the reaction force of pressing the tip mounting unit 143 against the tip, causing the lightweight dispensing unit 14 to tilt (FIG. 3(b), the dispensing unit 14 is tilted counterclockwise). If the dispensing unit 14 is tilted, the tip mounting unit 143 does not engage well with the tip, which may cause the tip to come off during preprocessing or may cause a deviation in the adjustment of the height of the tip of the tip. It is considered that the tilt can be suppressed if the dispensing unit 14 is configured such that the height adjustment unit 141 and the tip mounting unit 143 are coaxial (the tip mounting unit 143 is directly below the height adjustment unit 141) or if it is made of a heavy material, but these changes are difficult from the viewpoint of apparatus design. Therefore, in step S1, while pressing the tip mounting unit 143 against the tip, the dispensing unit 14 is moved to the side opposite to the arm 142 (tip mounting unit 143) with respect to the height adjustment unit 141, in other words, the tip mounting unit 143 is moved toward the height adjustment unit 141 side (substantially horizontally to the left in the drawing) (FIG. 3(c)). The amount of movement is preferably 1 mm to 3 mm. By doing so, a torque in the opposite direction to the torque generated by the reaction force of pressing the tip mounting unit 143 against the tip acts on the tip mounting unit 143, and the dispensing unit 14 can be appropriately engaged with the tip without tilting (FIG. 3(d)). Thereafter, the dispensing unit 14 is raised straight up (FIG. 3(e)). At this time, in order to prevent the tip from getting caught in the tip holding unit 16, it is preferable to move the dispensing unit 14 in the opposite direction (substantially horizontally to the right in the drawing) by the amount moved to the side opposite to the arm 142 (tip mounting unit 143) with respect to the height adjustment unit 141 while raising the dispensing unit 14 (FIG. 3(f)). Note that the operation of moving the dispensing unit 14 substantially perpendicular to the up-and-down movement of the tip mounting unit 143 shown in FIG. 3(c) and 3(f) can be performed by the moving plate 12.

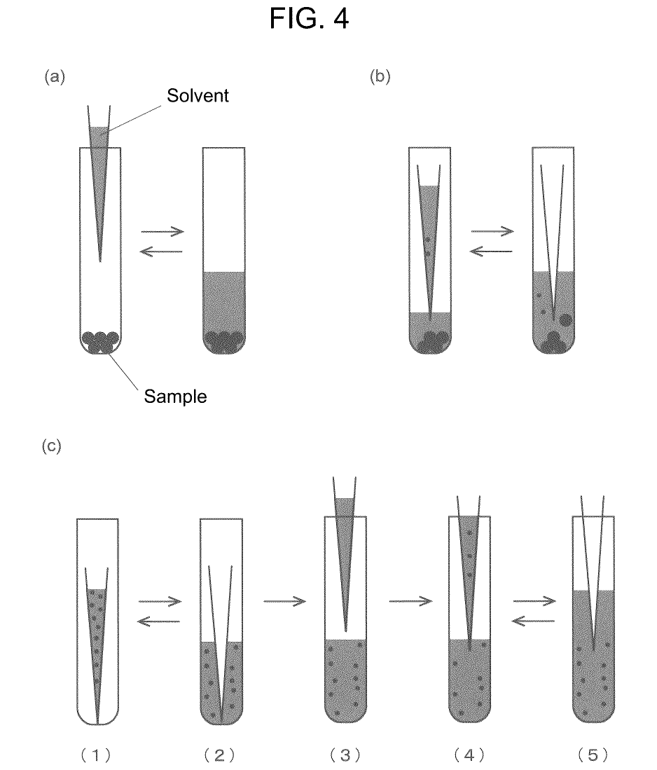

FIG. 4 is a diagram schematically showing a state where a solvent is added to a sample container and agitated in the embodiment. In step S2, the control unit 23 controls the dispensing unit 14 and the container holding unit 15 to repeat the operation of suctioning the solvent from the solvent container and discharging it into the sample container to be preprocessed one or more times until the reference amount of the solvent is added to the sample container (FIG. 4(a)). The operation may be performed with the target sample container and solvent container held in the container holding unit 15, or may be performed after controlling the container take-out unit 13 to move the target sample container from the container holding unit 15 to the centrifugation unit 17. After adding the solvent to the sample container, the dispensing unit 14 performs agitation by repeatedly suctioning/discharging the mixture of the sample and the solvent with the tip (specifically, by performing suction and discharge at least once each) (FIG. 4(b)). At this time, in order to improve the agitation efficiency, it is preferable that the amount of the mixture of the sample and the solvent is equal to or less than the maximum amount that can be suctioned by the tip at one time. That is, it is preferable that the dispensing unit 14 adds the solvent to the sample container one or more times so that the amount of the mixture of the sample and the solvent becomes equal to or less than the maximum amount that the tip can suction at one time, and repeatedly suctions/discharges the mixture with the tip (FIG. 4(c)(1), (2)). Since the amount of the mixture of the sample and the solvent is equal to or less than the maximum amount that the tip can suction at one time, the entire mixture of the sample and the solvent is suctioned into the tip. At this time, the sample rapidly rises in the tip and is also exposed to vigorous convection in the mixture, so that the sample is efficiently agitated in the process of being suctioned into the tip. The operation of repeatedly suctioning/discharging the mixture of an amount equal to or less than the maximum amount that the tip can suction at one time is preferably performed in the first unit preprocessing in order to quickly enhance the agitated state of the sample. Note that, after repeatedly suctioning/discharging the mixture of an amount equal to or less than the maximum amount that the tip can suction at one time, the solvent may be further added so that the amount of the solvent in the sample container becomes the reference amount, and then the mixture may be repeatedly suctioned/discharged with the tip (FIG. 4(c)(3) to (5)). By doing so, the degree of agitation of the sample in the mixture to which the sample and the reference amount of solvent have been added can be more reliably enhanced.

When the present inventor performed an agitation operation on an E. coli pellet using water as a solvent and setting the amount of the mixture of the sample and the solvent to be equal to or less than the maximum amount that the tip can suction at one time (1 ml), the sample was sufficiently agitated at the point when suction/discharge was performed five times each. Compared to the conventional agitation method, in which the amount of the mixture of the sample and the solvent is larger than the maximum suction amount of the tip at one time, the number of times of suction/discharge was reduced by about five times. In addition, the time required for the agitation operation was shortened by about 1 minute (6 seconds×5 agitation cycles×2 agitation phases).

In step S3, the control unit 23 controls the container take-out unit 13 to move the sample container housing the mixture of the sample and the solvent prepared in step S2 from the container holding unit 15 to the centrifugation unit 17 (this operation is unnecessary if step S2 was performed after placing the sample container in the centrifugation unit 17), and causes the centrifugation unit 17 to centrifuge the mixture. The agitation operation of the mixture may be performed not by the dispensing unit 14 in step S2 as described above, but by the centrifugation unit 17 having an agitation function in step S3.

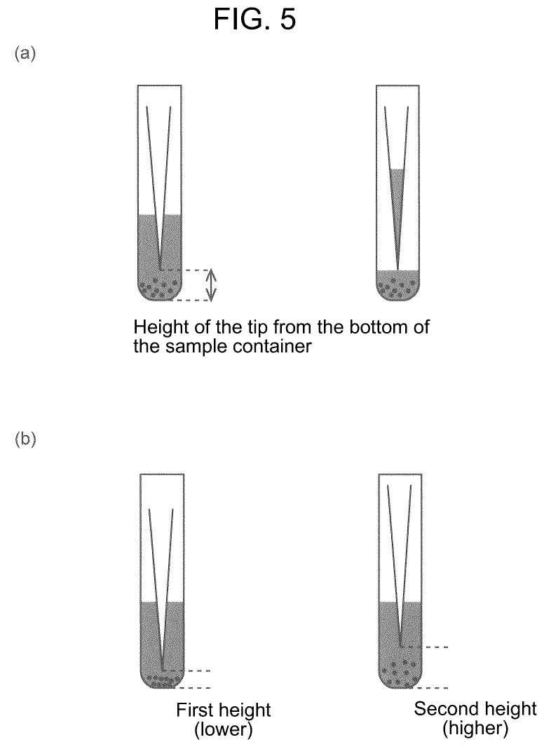

FIG. 5 is a diagram schematically showing a state where the supernatant obtained by centrifuging a mixture of a sample and a solvent is suctioned in the embodiment. In step S4, the control unit 23 controls the dispensing unit 14 to insert the tip into the sample container such that the tip of the tip is positioned at a predetermined height from the bottom of the sample container, and suctions the supernatant of the mixture of the sample and the solvent centrifuged in step S3. At this time, the height of the tip of the tip from the bottom of the sample container may be a preset value, or may be a height value obtained by detecting the height from the bottom of the sample container of the boundary between the precipitate and the supernatant with a sensor (not shown) or by determining the boundary using a camera. In any case, in step S4, all the supernatant located at a position higher than the tip of the tip is suctioned (FIG. 5(a)).

After the dispensing unit 14 suctions and disposes of the supernatant, the control unit 23 controls the dispensing unit 14 to detach the used tip at the tip detachment unit 18 and place it in the used tip case 19 (step S5). Thereafter, the control unit 23 checks whether the unit preprocessing consisting of steps S1 to S5 has been performed a predetermined number of times set in advance (step S6). If the unit preprocessing has been performed the predetermined number of times, the preprocessing for this sample is terminated. If the unit preprocessing has not been performed the predetermined number of times, steps S1 to S5 described above are performed again.

When unit preprocessing is performed two or more times on a sample such as a blood culture specimen, in a stage where the number of times centrifugation is performed is small, the substance to be analyzed and impurities contained in the sample are not completely separated and precipitate in a state of being aggregated with each other, so that even if the distance between the tip of the tip and the precipitate is short, it is rare for the precipitate to be suctioned by the tip. On the other hand, as the number of times centrifugation is performed increases, the degree of aggregation of the substance to be analyzed and the impurities decreases, and the precipitate becomes more likely to be suctioned by the tip.

Therefore, in the preprocessing method and the preprocessing apparatus according to the embodiment, when unit preprocessing is repeated multiple times, the height of the tip of the tip from the bottom of the sample container (first height) in a certain unit preprocessing (first unit preprocessing) is made lower than the height of the tip of the tip from the bottom of the sample container (second height) in the subsequent unit preprocessing (second unit preprocessing) (FIG. 5(b)). That is, the control unit 23 controls the dispensing unit 14 so that the height of the tip of the tip from the bottom of the sample container becomes the first height in the first unit preprocessing, and controls the dispensing unit 14 so that the height of the tip of the tip from the bottom of the sample container becomes the second height, which is higher than the first height, in the subsequent second unit preprocessing. As a result, in the first unit preprocessing, even if there is an error in the control of the dispensing unit 14 and the position of the tip becomes higher than expected, an amount of supernatant comparable to that in the second unit preprocessing can be suctioned, so the influence of the error can be reduced. Conversely, even if the position of the tip becomes lower than expected, the possibility that the tip will suction the precipitate is lower than in the second unit preprocessing. Then, since the supernatant is efficiently suctioned in the first unit preprocessing, the concentration of the substance contained in the supernatant suctioned in the second unit preprocessing is lower than that in the first unit preprocessing. Therefore, in the second unit preprocessing, even if the position of the tip becomes higher than expected, the amount of the substance contained in the supernatant that could not be suctioned is small, so the influence of the error is smaller than in the first unit preprocessing. In addition, in the second unit preprocessing, the degree of aggregation of the precipitate is lower than in the first unit preprocessing and it is more likely to be suctioned, so by making the position of the tip in the second unit preprocessing higher than that in the first unit preprocessing, the possibility of suctioning the precipitate can be reduced even if the position of the tip becomes lower than expected.

Usually, the boundary between the precipitate and the supernatant in the sample container is ambiguous, and it is difficult to accurately detect the height of the precipitate from the bottom of the sample container. In addition, the manner in which the tip engages with the tip mounting unit 143 is not uniform. Therefore, a great deal of effort is required to control the position of the tip with high precision. On the other hand, in the preprocessing method according to the embodiment, since the influence of an error in the position of the tip is small as described above, precise control of the dispenser is not necessary for efficient preprocessing, and the effort required for preprocessing is reduced. For example, in three unit preprocessing steps, conventionally, the tip was positioned at a position of 5 mm from the bottom of the sample container, but in this case, the error in the position of the tip needed to be suppressed to within ±0.3 mm. However, when the tip was positioned at a position of 3 mm from the bottom of the sample container in the first unit preprocessing, the error in the position of the tip in each unit preprocessing can be tolerated up to ±0.73 mm.

In the embodiment, since it is considered that the degree of aggregation of the substance to be analyzed and the impurities is highest in the first unit preprocessing, the first unit preprocessing is preferably the first unit preprocessing, but it may be the second or a subsequent unit preprocessing. In addition, there may be cases where two or more unit preprocessing steps correspond to the first unit preprocessing or the second unit preprocessing. Examples thereof include a case where the height of the tip of the tip from the bottom of the sample container in the first and third unit preprocessing steps is made lower than that in the second and fourth unit preprocessing steps, respectively, or a case where the height of the tip of the tip from the bottom of the sample container is gradually increased in three or more unit preprocessing steps (including a case where the height does not change in a part of consecutive unit preprocessing steps).

When the present inventor performed the above preprocessing on a blood culture specimen with the height of the tip of the tip from the bottom of the sample container being 2.94 mm (the height of the precipitate is about 1 mm) in the first unit preprocessing, and the height from the bottom of the sample container being 3.96 mm in the second and subsequent unit preprocessing, and other conditions being the same as in the conventional preprocessing method, a final sample with sufficient purity was obtained in the third unit preprocessing. Compared to the conventional preprocessing method in which the height of the tip of the tip from the bottom of the sample container is the same in each unit preprocessing, the number of unit preprocessing steps was also reduced. In addition, the time required for preprocessing was also shortened.

Note that the rail 11, the moving plate 12, and the container take-out unit 13 may be realized by a known robot arm in addition to those shown in the drawings. In that case, the dispensing unit 14 may be attached to the robot arm, or may be a portable type dispenser.

### Aspects

It is obvious to those skilled in the art that the exemplary embodiments described above are specific examples of the following aspects.

(Aspect 1) A preprocessing method according to one aspect of the present invention is a preprocessing method for performing unit preprocessing two or more times on the same sample, the unit preprocessing sequentially performing: a solvent addition step of adding a solvent to a sample container housing a sample to prepare a mixture of the sample and the solvent; a centrifugation step of centrifuging the mixture; and a suction step of inserting a suction tube into the sample container such that a height of a tip thereof from a bottom of the sample container becomes a predetermined height, and suctioning a supernatant of the mixture with the suction tube, the preprocessing method having, as the unit preprocessing, a first unit preprocessing and a second unit preprocessing performed after the first unit preprocessing, wherein the predetermined height in the suction step of the first unit preprocessing is a first height, and the predetermined height in the suction step of the second unit preprocessing is a second height that is higher than the first height.

(Aspect 2) A preprocessing apparatus according to one aspect of the present invention comprises: a container holding unit that holds a sample container; a suction tube mounting unit to which a suction tube is detachably mounted; a suction and discharge unit that suctions and discharges a liquid with respect to the sample container held by the container holding unit through the suction tube mounted to the suction tube mounting unit; a centrifugation unit; a container moving unit that grips the sample container and moves the sample container between the container holding unit and the centrifugation unit; and a control unit that controls the suction and discharge unit and the container moving unit, wherein the control unit sequentially performs, on the same sample, a first unit preprocessing and a second unit preprocessing, which are unit preprocessing for sequentially performing: a solvent addition step of adding a solvent to the sample container held by the container holding unit to prepare a mixture of a sample and the solvent; a first moving step of moving the sample container from the container holding unit to the centrifugation unit; a second moving step of moving the sample container, after the mixture has been centrifuged in the centrifugation unit, to the container holding unit; and a suction step of inserting the suction tube into the sample container held by the container holding unit such that a height of a tip thereof from a bottom of the sample container becomes a predetermined height, and suctioning a supernatant of the mixture with the suction tube, wherein the first unit preprocessing sets the predetermined height in the suction step to a first height, and the second unit preprocessing sets the predetermined height in the suction step to a second height that is higher than the first height.

(Aspect 3) The preprocessing apparatus according to Aspect 2, wherein the control unit performs the unit preprocessing three or more times on the same sample, and performs one of the first unit preprocessing and the second unit preprocessing multiple times.

(Aspect 4) The preprocessing apparatus according to Aspect 2, wherein the control unit performs the unit preprocessing three or more times on the same sample, and the three or more unit preprocessing steps include the first unit preprocessing, the second unit preprocessing performed after the first unit preprocessing, and a unit preprocessing performed after the second unit preprocessing in which the predetermined height in the suction step is higher than the second height.

The present inventor has found that in preprocessing in which a series of operations of adding a solvent to a sample container housing a sample, centrifuging this, and suctioning the supernatant with a suction tube is performed one or more times, in a stage where the number of times centrifugation is performed is small, a substance to be analyzed and impurities are not completely separated and precipitate in a state of being aggregated with each other, so that even if the distance between the tip of the tip and the precipitate is short, it is rare for the precipitate to be suctioned by the tip, and that as the number of times centrifugation is performed increases, the degree of aggregation of the substance to be analyzed and the impurities decreases, and the precipitate becomes more likely to be suctioned by the tip, and has completed the present invention.

According to the preprocessing method according to Aspect 1 and the preprocessing apparatus according to Aspects 2 to 4, the height of the tip of the suction tube from the bottom of the sample container in the suction step of the first unit preprocessing is lower than that in the suction step of the second unit preprocessing performed after the first unit preprocessing. Therefore, in the suction step of the first unit preprocessing, even if there is an error in the control of the suction tube and the position of its tip becomes higher than expected, an amount of supernatant comparable to that in the suction step of the second unit preprocessing can be suctioned, so the influence of the error can be reduced. Conversely, even if the position of the tip of the suction tube becomes lower than expected, the possibility that the suction tube will suction the precipitate is lower than in the suction step of the second unit preprocessing. Then, since the supernatant is efficiently suctioned in the suction step of the first unit preprocessing in this way, the concentration of the substance contained in the supernatant suctioned in the suction step of the second unit preprocessing is lower than that in the suction step of the first unit preprocessing. Therefore, in the suction step of the second unit preprocessing, even if the position of the tip of the suction tube becomes higher than expected, the amount of the substance contained in the supernatant that could not be suctioned is small, so the influence of the error is smaller than in the suction step of the first unit preprocessing. In addition, in the suction step of the second unit preprocessing, the degree of aggregation of the precipitate is low and the precipitate is more likely to be suctioned, so by making the position of the tip of the suction tube in the suction step of the second unit preprocessing higher than that in the suction step of the first unit preprocessing, the possibility of suctioning the precipitate can be reduced even if the position of the tip of the suction tube becomes lower than expected.

Therefore, according to the preprocessing method according to Aspect 1 and the preprocessing apparatus according to Aspects 2 to 4, since the allowable range of the control error of the dispenser is wide, the effort required for preprocessing is reduced.

(Aspect 5) The preprocessing apparatus according to Aspect 2, wherein, in the first unit preprocessing or the second unit preprocessing, the control unit causes the suction and discharge unit to perform an agitation step of suctioning and discharging the entire amount of the mixture in the sample container after the solvent addition step.

According to the preprocessing apparatus of Aspect 5, the entire mixture of the sample and the solvent is suctioned into the suction tube. At this time, the sample rapidly rises in the suction tube and is also exposed to vigorous convection in the mixture, so that the sample is efficiently agitated in the process of being suctioned into the suction tube.

(Aspect 6) The preprocessing apparatus according to Aspect 5, wherein, after causing the suction and discharge unit to perform the agitation step, the control unit causes the suction and discharge unit to perform a second agitation step of further discharging the solvent into the sample container and suctioning and discharging the resulting mixture in the sample container.

According to the preprocessing apparatus of Aspect 6, the degree of agitation of the sample can be more reliably enhanced.

(Aspect 7) The preprocessing apparatus according to Aspect 2, further comprising: a suction tube holding unit; and a position adjustment unit provided on a side that is not directly above the suction tube mounting unit and that adjusts a position of the suction tube mounting unit with respect to the suction tube holding unit, wherein, before the solvent addition step in the first unit preprocessing, the control unit causes the suction tube mounting unit to approach the suction tube holding unit and to move toward the position adjustment unit side while being in contact with a suction tube held by the suction tube holding unit.

(Aspect 8) The preprocessing apparatus according to Aspect 7, wherein, after the suction tube mounting unit has moved toward the position adjustment unit side while being in contact with the suction tube held by the suction tube holding unit, the control unit causes the suction tube mounting unit to move away from the suction tube holding unit while moving in a direction opposite to the position adjustment unit side.

According to the preprocessing apparatus of Aspects 7 and 8, a torque in the opposite direction to the torque generated by the reaction force when connecting the suction tube mounting unit to the suction tube acts on the suction tube mounting unit, so that the suction tube mounting unit does not tilt, and thus the suction tube mounting unit and the suction tube can be appropriately connected.

### Reference Signs List

1 . . . Preprocessing apparatus 11 . . . Rail 12 . . . Moving plate 13 . . . Container take-out unit 131 . . . Hand 14 . . . Dispensing unit 141 . . . Height adjustment unit 142 . . . Arm 143 . . . Tip mounting unit 15 . . . Container holding unit 16 . . . Tip holding unit 17 . . . Centrifugation unit 18 . . . Tip detachment unit 19 . . . Used tip case 20 . . . Computer 21 . . . Display unit 22 . . . Input unit 23 . . . Control unit 24 . . . Storage unit

What is claimed is

1. A preprocessing method for performing unit preprocessing two or more times on the same sample, the unit preprocessing sequentially performing: a solvent addition step of adding a solvent to a sample container housing a sample to prepare a mixture of the sample and the solvent; a centrifugation step of centrifuging the mixture; and a suction step of inserting a suction tube into the sample container such that a height of a tip thereof from a bottom of the sample container becomes a predetermined height, and suctioning a supernatant of the mixture with the suction tube, the preprocessing method comprising, as the unit preprocessing, a first unit preprocessing and a second unit preprocessing performed after the first unit preprocessing, wherein the predetermined height in the suction step of the first unit preprocessing is a first height, and the predetermined height in the suction step of the second unit preprocessing is a second height that is higher than the first height.

2. A preprocessing apparatus, comprising: a container holding unit that holds a sample container; a suction tube mounting unit to which a suction tube is detachably mounted; a suction and discharge unit that suctions and discharges a liquid with respect to the sample container held by the container holding unit through the suction tube mounted to the suction tube mounting unit; a centrifugation unit; a container moving unit that grips the sample container and moves the sample container between the container holding unit and the centrifugation unit; and a control unit that controls the suction and discharge unit and the container moving unit, wherein the control unit is configured to sequentially perform, on the same sample, a first unit preprocessing and a second unit preprocessing, which are unit preprocessing for sequentially performing: a solvent addition step of adding a solvent to the sample container held by the container holding unit to prepare a mixture of a sample and the solvent; a first moving step of moving the sample container from the container holding unit to the centrifugation unit; a second moving step of moving the sample container, after the mixture has been centrifuged in the centrifugation unit, to the container holding unit; and a suction step of inserting the suction tube into the sample container held by the container holding unit such that a height of a tip thereof from a bottom of the sample container becomes a predetermined height, and suctioning a supernatant of the mixture with the suction tube, wherein the first unit preprocessing sets the predetermined height in the suction step to a first height, and the second unit preprocessing sets the predetermined height in the suction step to a second height that is higher than the first height.

3. The preprocessing apparatus according to claim 2, wherein the control unit is configured to perform the unit preprocessing three or more times on the same sample, and to perform one of the first unit preprocessing and the second unit preprocessing multiple times.

4. The preprocessing apparatus according to claim 2, wherein the control unit is configured to perform the unit preprocessing three or more times on the same sample, and the three or more unit preprocessing steps include the first unit preprocessing, the second unit preprocessing performed after the first unit preprocessing, and a unit preprocessing performed after the second unit preprocessing in which the predetermined height in the suction step is higher than the second height.

5. The preprocessing apparatus according to claim 2, wherein, in the first unit preprocessing or the second unit preprocessing, the control unit is configured to cause the suction and discharge unit to perform an agitation step of suctioning and discharging the entire amount of the mixture in the sample container after the solvent addition step.

6. The preprocessing apparatus according to claim 5, wherein, after causing the suction and discharge unit to perform the agitation step, the control unit is configured to cause the suction and discharge unit to perform a second agitation step of further discharging the solvent into the sample container and suctioning and discharging the resulting mixture in the sample container.

7. The preprocessing apparatus according to claim 2, further comprising: a suction tube holding unit; and a position adjustment unit provided on a side that is not directly above the suction tube mounting unit and configured to adjust a position of the suction tube mounting unit with respect to the suction tube holding unit, wherein, before the solvent addition step in the first unit preprocessing, the control unit is configured to cause the suction tube mounting unit to approach the suction tube holding unit and to move toward the position adjustment unit side while being in contact with a suction tube held by the suction tube holding unit.

8. The preprocessing apparatus according to claim 7, wherein, after the suction tube mounting unit has moved toward the position adjustment unit side while being in contact with the suction tube held by the suction tube holding unit, the control unit is configured to cause the suction tube mounting unit to move away from the suction tube holding unit while moving in a direction opposite to the position adjustment unit side.
